(19) United States
(12) Patent Application Publication
(10) Pub. No.: US 2009/0169782 A1
(43) Pub. Date: Jul. 2, 2009

(54) PROCESS FOR CRYSTALLIZING AND SOLID STATE POLYMERIZING POLYMERS AND THE COATED POLYMER

(75) Inventor: Wei-Ching Yu, Marietta, GA (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: Invista North America S AR L, Wilmington, DE (US)

(21) Appl. No.: 11/719,231

(22) PCT Filed: Nov. 22, 2004
(86) PCT No.: PCT/US2004/039348

§ 371 Date: Dec. 11, 2008

(51) Int. Cl. B05D 7/02; B32B 5/16; B32B 27/06

(52) U.S. Cl. 428/35.7; 428/336; 427/222

(57) ABSTRACT

This invention relates to a process for crystallizing and solid state polymerizing polymers, in the form of amorphous pellets by coating the pellets with a coating of 50 to 250 ppm of an anti-sticking agent to the amorphous pellets. The invention also relates to such a coated pellet. The coated pellet is then heated such that its surface is at least partially crystallized or essentially crystallized. Next it is solid state polymerize to a high molecular weight. The capacity of the crystallization and solid state polymerization process can be increased by using higher temperatures when the anti-sticking agent is present as compared to a normal process using the same polymer. The preferred anti-sticking agents are chosen to give high clarity to articles made from the high molecular weight pellet. The preferred anti-slicking agent is fumed silica, but other organic and inorganic coatings may be used.

### BACKGROUND OF THE INVENTION

1) Field of the Invention

This invention relates to a process for crystallizing and solid state polymerizing polymers, in the form of amorphous pellets. Specifically the process comprises the coating of 50 to 250 ppm of an anti-sticking agent to the amorphous pellets. The coated pellet is at least partially crystallized and then solid state polymerized to a high molecular weight. The capacity of the crystallization and solid state polymerization processes can be increased by using higher temperatures when the anti-sticking agent is present as compared to normal processes using the same polymer. The preferred anti-sticking agents are chosen to give high clarity to articles made from the high molecular weight pellet. The present invention also covers the coated pellets.

2) Prior Art

Polymers are generally prepared by a melt phase polymerization to a low dr intermediate molecular weight. Higher molecular weight polymers are then produced by solid state polymerization Processes for the thermal treatment of polymer pellets in the solid state are preceded by at least a partial crystallization of the surface of the amorphous pellet. The purpose of crystallization through initial thermal treatment prior to subsequent thermal treatment at increased temperatures used in solid state polymerization is to prevent sticking of the pellets at this reaction stage. As amorphous polymer pellets are heated above their glass transition temperature they have a strong tendency to stick together. As the temperature increases the amorphous pellets start to crystallize from the outside. Once there is at least a partial crystalline layer on the outside of the pellet there is less tendency for the pellets to stick. Since crystallization of polymers is an exothermic reaction, it is imperative that the pellets are crystalline prior to solid state polymerization. Otherwise the heat of crystallization can cause localized over-heating of the pellets causing them to sinter together.

Many techniques have been proposed to minimize this sticking of amorphous polymer as it is heated. U.S. Pat. No. 3,728,309 to Maxion discusses many of the techniques that have been employed to minimize agglomeration Various references have suggested the use of inorganic powders, such as talc, which function as anti-stick agents, U.S. Pat. No. 3,544,523 to Maxion discloses that suitable proportions of anti-caking additives may range from about 0.1 (1000 ppm) up to 10% or more of the weight of the resin. Maxion teaches that smaller particles are more effective in preventing agglomeration of the resin, with a preferred particle size of less than 40 mesh (425 micron). In the case where the anti-caking material is not removed from the solid stated resin, transparent final products are obtainable in certain cases as in employing fumed silica Example 2 of U.S. Pat. No. 3,544,523 discloses the use of 1 weight % of silica aerosol as an anti-caking additive.

Belgium Pat. No. 765 525 assigned to Sandoz discloses the use of various inorganic solids and liquids to prevent sticking. Silicon oils are preferred since they also coat the walls of the vessels. The preferred level of additives is in the range 0.01 (100 ppm) to 5 weight %, particularly 0.05 to 5 weight %. The examples use amounts in the range of 0.3 to 1 weight %.

U.S. Pat. No. 4,008,206 to Chipman et al discloses the use of organic crystalline anti-stick agents. The preferred concentration is 0.05 (500 ppm) to 10 parts by weight per 1100 by weight polyester.

U.S. Pat. No. 4,130,551 to Bockrath discloses the use of a water soluble anti-stick agent.

This is removed by washing the pellets after solid state polymerization. U.S. Pat. No. 5,523,361 to Tung et al. discloses coating amorphous polyethylene naphthalate pellets with an allylene carbonate to increase the crystallization rate to minimize the tendency of the pellets to stick together A similar approach for blends of polyethylene terephthalate and polyethylene isophthalate was disclosed in U.S. Pat. No 5,919,872 to Tung et al.

U.S. Pat. No. 5,540,868 to Stouffer et al discloses a process in which low molecular weight polyesters are rapidly crystallized by a thermal shock process thus eliminating the need for a separate crystallization process prior to solid-state polymerization.

There are two types of equipment generally used for crystallization of polyester resins. Mechanical devices such as described in U.S. Pat. No. 4,161,578 to Herron utilizes a combination of a high mechanical agitation, high heat transfer apparatus with a gentle mechanical agitation low heat exchange apparatus. Alternately a fluidized bed crystallizer as described in U.S. Pat. No. 5,090,134 to Rüssemeyer et al is used. Heat transfer occurs between the amorphous pellet and the hot gas used to fluidize the beds. In this apparatus the polyester material is guided through two fluidized beds arranged ill series of which the first is an effervescent fluidized layer with a mixing characteristic and the second is a flow bed with a plug flow characteristic. In both processes the equipment throughput is limited by the crystallization process, and the need to avoid amorphous polyester pellets from sticking to each other, or to the walls of the equipment. Additionally there have been attempts to crystallize resins using ultrasonic vibrations, and to heat in the crystallization stage using infrared radiation.

The prior art use of anti-stick additives required an additional step after solid state polymerization to remove die additive. If this could not be done, then it would be unacceptable for use in critical applications such as transparent bottles or films.

There is therefore a need for a solution to the problem of amorphous polymer pellets sticking when heated, that has slight or no effect on the properties of the final solid state polymerized resin for critical applications, and that allows a higher heat transfer rate to be achieved in the crystallization and solid state polymerization equipment.

### SUMMARY OF THE INVENTION

The present invention is based on the discovery that lower amounts of anti-sticking agents (than taught in the prior art) are sufficient to prevent the surface of polymer pellets from agglomerating in a crystallization process. Depending on the process conditions, which are different for each polymer, the surface of the polymer pellets is at least partially crystalline to crystalline This finding allows a faster crystallization and solid state polymerization process to be used through the resulting use of higher temperature processes. More specifically the invention relates to coating polymer pellets with fine particles with an average particle size of less than 2 micron at a level of less than 250 ppm by weight, preferably less than 150 ppm by weight; then subjecting the polymer pellets to the crystallization and solid-state processes.

Accordingly, the invention in one of its embodiments is a method of solid state polymerization of polymer pellets, which comprises:
a) contacting amorphous polymer pellets with particles having an average size of less than about 2 microns to a loading of less than about 250 ppm by weight; and
b) heating the coated pellets to a temperature effective to at least partially crystallize at least a portion of the surface of the coated pellets: and
c) subjecting said at least partially crystallized coated polymer pellets to a solid state polymerization process.

Another embodiment of the invention is a coated polymer pellet, said coating particles having an average size of less than about 2 microns at a loading of less than about 250 ppm by weight. The coated polymer pellet may be amorphous, have a surface which is partially crystalline, or a surface that is essentially crystalline. The preferred coating particle is fumed silica.

The invention also contemplates the use of the solid stated polymer pellets in typical end uses where high molecular weight polymers are required, for example, industrial yarns or blow molded containers.

In particular the invention relates to a coating of fumed silica on polyester pellets and its use in clear injection stretch blow molded containers.

### DETAILED DESCRIPTION OF THE INVENTION

Polyesters, copolyesters, polycarbonates, copolycarbonates, polyamides, and copolyamides, or mixtures of these are the most common polymers that utilize a solid state polymerization process to obtain a high molecular weight polymer.

Generally polyesters or copolyesters can be prepared by one of two processes, namely: (1) the ester process and (2) the acid process. The ester process is where at least one dicarboxylic ester (such as dimethyl terephthalate) is reacted with at least one diol (such as ethylene glycol) in an ester interchange reaction. Because the reaction is reversible, it is generally necessary to remove the alcohol (methanol when dimethyl terephthalate is employed) to completely convert the raw materials into monomer. Monomers so prepared contain mixtures of short chain oligomers and in some cases small amounts of the starting materials. Certain catalysts are well known for use in the ester interchange reaction. In the past, catalytic activity was then sequestered by introducing a phosphorus compound, for example polyphosphoric acid, at the end of the ester interchange reaction. Primarily the ester interchange catalyst was sequestered to prevent yellowness from occurring in the polymer.

Then the monomer undergoes polycondensation and the catalyst employed in this reaction is generally an antimony, germanium, or titanium compound, or a mixture of these or other similar well known metal compounds.

In the second method for making polyester or copolyester, at least one dicarboxylic acid (such as terephthalic acid) is reacted with at least one diol (such as ethylene glycol) by a direct esterification reaction producing monomer and water. Monomer so prepared contains mixtures of short chain oligomers and in some cases small amounts of the starting materials. This reaction is also reversible like the ester process and thus to drive the reaction to completion one must remove the water. In most cases the direct esterification step does not require a catalyst. The monomer then undergoes polycondensation to form polyester just as in the ester process, and the catalyst and conditions employed are generally the same as those for the ester process.

Suitable polyesters are produced from the reaction of a diacid or diester component comprising at least 65 mol-% terephthalic acid or C₁-C₄ dialkylterephthalate, preferably at least 70 mol-%, more preferably at least 75 mol-%, even more preferably, at least 90 mol-% of the acid moieties in the diacid or diester component, mid a diol component comprising at least 65% mol-% ethylene glycol, or C₂-C₂₀ diglycols preferably at least 70 mol-%, more preferably at least 75 mol-%, even more preferably at least 95 mol-% of the diol moieties in the diol component. It is also preferable that the diacid component is terephthalic acid and the diol component is ethylene glycol, thereby forming polyethylene terephthalate (PET). The mole percent for all the diacid component totals 100 mol-%, and the mole percentage for all the diol component totals 100 mol-%.

Where the polyester components are modified by one or more diol components other than ethylene glycol, suitable diol components of the described polyester may be selected from 1,4-cyclohexandedimethanol; 1,2-propanediol; 1,4-butanediol; 2,2-dimethyl-1,3-propanediol; 2-methyl-1,3-propanediol (2MPDO); 1,6-hexanediol; 1,2-cyclohexanediol; 1,4-cyclohexanediol; 1,2-cyclohexanedimethanol; 1,3-cyclohexanedimethanol, and diols containing one or more oxygen atoms in the chain, e.g., diethylene glycol, triethylene glycol, dipropylene glycol, tripropyleneglycol or mixtures of these, and the like. In general, these diols contain 2 to 18, preferably 2 to 8 carbon atoms Cycloaliphatic diols can be employed in their cis or trans configuration or as mixture of both forms. Preferred modifying diol components are 1,4-cyclohexanedinethanol or diethylene glycol, or a mixture of these.

Where the polyester components are modified by one or more acid components other than terephthalic acid, the suitable acid components (aliphatic, alicyclic, or aromatic dicarboxylic acids) of the resulting linear polyester may be selected, for example, from isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid, bibenzoic acid, or mixtures of these and the like. In the polymer preparation, it is often preferable to use a functional acid derivative thereof such as the dimethyl, diethyl, or dipropyl ester of the dicarboxylic acid. The anhydrides or acid halides of these acids also may be employed where practical. These acid modifiers generally retard the crystallization rate compared to terephthalic acid. Most preferred is the copolymer of PET and isophthalic acid. Generally the isophthalic acid is present from about 0.5 to about 10 mole %, and preferably about 1.0 to 7 mole % of the copolymer.

In addition to polyester made from terephthalic acid (or dimethyl terephthalate) and ethylene glycol, or a modified polyester as stated above, the present invention also includes the use of 100% of an aromatic diacid such as 2,6-napthalene dicarboxylic acid or bibenzoic acid, or their diesters, and a modified polyester made by reacting at least 85 mol-% of the dicarboxylate from these aromatic diacids/diesters with any of the above comonomers.

As used herein, polycarbonate includes copolymers and polyester carbonates. The most common polycarbonate is based on bisphenol A. Polycarbonates are prepared commercially by two processes: Schotten-Baumann reaction of phosgene and an aromatic diol in an amine catalyzed interfacial condensation reaction; or via a base catalyzed transesterification of a bisphenol with a monomeric carbonate.

Polyamides, such as nylon 6,6, or copolyamides are generally prepared by melt phase polymerization from at least one diacid-diamine complex (salt) which may be prepared either in situ or in a separate step. In either method, the diacid and diamine are used as starting materials. When the diacid-diamine complex is used, the mixture is heated to melting and stirred until equilibrium is reached. The polymerization or copolymerization can be carried out either at atmospheric pressure or at elevated pressures or under vacuum. Polyamides formed from amino acids such as nylon 6, are generally produced by the ring opening of the corresponding lactam. The most common method is hydrolytic polymerization, in which lactams are heated in the presence of water above the melting point of the polyamide. The hydrolytic ring opening can be catalyzed by an acid or a base. The resulting amino acid then condenses in a stepwise manner to form the growing polymer chain. In anionic polymerization the reaction is initiated by a strong base, e.g. a metal hydride, alkali metal oxide, organometallic compounds, or hydroxides to form a lactamate. The lactamate then initiates a two-step reaction which adds a molecule of the lactam to the polymer chain. Lactams can also be polymerized under anhydrous conditions by a cationic mechanism initiated by strong protic acids, their salts, Lewis acids, as well as amines and ammonia.

As used herein the term “pellets” refers to the discrete particle form of die polymer. During melt phase polymerization, the amorphous polymer is extruded into strands which are quenched and cut into the desired pellet, cube, chip or other small particle form. In the case of low molecular weight polymers the pellets may be formed by pastillation or by spraying from a nozzle to produce melt droplets. As used herein the term “amorphous” refers to the pellets obtained directly from the melt phase polymerization process. Once the processes of the invention have been conducted, the amorphous pellets become at least partially crystalline on their surface.

The coating particles can be inorganic or organic in nature. Inorganic particles include minerals of natural occurrence such as talc, kaolin, gypsum, etc. Many inorganic oxides are also suitable including the oxides and carbonates of silicon, aluminum, titanium, calcium, iron and magnesium. Carbon pigments such as carbon blacks and graphite, as well as inorganic pigments may be used. Fumed silicas are particularly preferred for polymers that are used in the formation of clear articles. Organic particles that have a melting point higher than the glass transition temperature of the polymer may also be employed. Typical organic compounds include alkylene carbonates, such as ethylene or propylene carbonates, terephthalic acid, phthalic anhydride, succinic anhydride, as well as particles of crystallized polymers. The average particle size of the coating particles is less than about 2 micron. As the average particle size exceeds 2 microns (at a constant mass loading), sticking starts to increase because the coating particles do not cover the surface of the pellets as well (the finer the particle, the more surface area the particle has and the more it can cover the pellets). The amount of coating particles used is not meant to completely cover the exterior surface of the pellets. To reduce the stickiness to an acceptable level, only about 20% of the exterior surface of the pellets needs to be covered and that can be accomplished at a level of less than 250 ppm by weight, preferably less than about 150 ppm by weight of the coating particle with a size of less than 2 microns.

The pellets are mixed with the particles under conditions that distribute the particle more or less evenly over the pellet surface. The particles can be applied, for example, by dry blending with the pellets. The pellets can be coated by placing them in an aqueous solution of the particles, and then removing the water. The pellets may be sprayed with the particles either in the semisolid state during extrusion or pastillation, or when they have been quenched.

Amorphous and or partially crystalline chips coated with the anti-sticking agent, prepared according to the method above, or according to other batch and continuous methods in which the amorphous chip is subject to heat in the presence of the anti-sticking agent for a specific time at a specific temperature, are then subjected to solid phase polymerization in one of the many ways known in the art, for example, by heating, with tumbling, in a batch vacuum tumble dryer or by passing continuously through a column in the presence of an inert gas, to increase the molecular weight to a level suitable for use as industrial fibers, engineering resin or for injection stretch blow molding into bottles.

Testing Procedures

A standard laboratory rotary evaporator system was used to determine the crystallization temperature and degree of pellet agglomeration. The unit consists of a one-liter round flasks angled at 45 so that the bottom half of the flask was immersed in a temperature controlled oil bath. The flask was connected to a variable drive motor so that the flask could be rotated in the oil bath. A weighed quantity of the coated pellets was placed in the flask, and the flask lowered into the oil bath, which is already at the required temperature of the experiment. The flask was rotated at 30 rpm. The amorphous pellets are clear in color, and the time at which they all became white in appearance was taken to be the crystallization time. At the end of the time of the trial, the flask was removed from the oil bath and allowed to cool to room temperature. The percentage of pellets stuck together; or on the wall of the flask, was measured by emptying the contents of the flask and weighing the free (unstuck) pellets.

The coefficient of friction of bottle sidewalls was measured according to ASTM D1894. The haze of the bottle sidewalls was measured using a Hunter haze meter. The silicon content of the pellets and bottles was measured by an ICP (inductively coupled plasma) atomic emission spectrometer. The Intrinsic Viscosity (IV) of the pellets was measured according to ASTM D4603-03.

Unless otherwise stated, the amorphous pellets were based on a commercial bottle polyethylene terephthalate (PET) resin containing up to 3.0 mole % isophthalic acid, having an IV of about 06. The pellets were cylindrical in shape with a diameter of about 2 mm and a length of about 2.2 mm. The quantity of pellets used was 200 grams.

### Example 1

A fumed silica (Cab-O-Sil® M-7D, Cabot Corporation, Billerica, Mass., USA) having an average aggregate length of 0.2 to 0.3 microns (B.E.T surface area of 200 m²/g) was dry blended at different loadings. The crystallization time and the % stuck pellets after 12 minutes at a temperature of 200° C. were measured, and the results set forth in Table 1.

TABLE 1

| Cab-O-Sil, ppm | Crystallization time, min. | Percent stuck |
|---|---|---|
| 0 | 8.85 | 100 |
| 10 | 8.60 | 99 |
| 20 | 8.20 | 95 |
| 30 | 7.80 | 60 |
| 40 | 7.38 | 50 |
| 50 | 5.57 | 1 |
| 60 | 4.58 | <1 |
| 70 | 4.28 | <1 |

These results indicate that at about 50 ppm the pellets cease to stick together, and this transition is accompanied by a decrease in crystallization time due to free flow of the coated chips that resulted in an increased rate of heat transfer.

### Example 2

The experiment described in Example 1 was repeated using two loadings of Cab-O-Sil (55 and 70 ppm) over a range of temperature. The results are set forth in Table 2.

TABLE 2

| | Cab-o-Sil loading, ppm | | | |
|---|---|---|---|---|
| | 55 | | 70 | |
| | Crystallization | | Crystallization | |
| Oil Temp, ° C. | time, min. | % stuck | time, min. | % stuck |
| 210 | 5.08 | <1 | 3.75 | <1 |
| 220 | 4.48 | <1 | 3.63 | 1 |
| 230 | 5.77 | 60 | 3.55 | 5 |
| 240 | 5.57 | 70 | 3.45 | 10 |
| 250 | 5.92 | 90 | 3.33 | 50 |

The higher (70 ppm) particle loading decreased the crystallization time, indicating a better heat transfer from the flask wall to the pellets due to less sticking of the pellets together. Photomicrographs show that at 70 ppm the fumed silica aggregates cover about 20% of the surface area of the pellets. The degree of coverage specified in this example is not meant to limit all the variations of the invention. Finer particles may be acceptable with lesser amounts of particles (less ppm), yet remain acceptable.

### Example 3

A series of framed silica (HDK®) were obtained from Wacker Chemie, Munich, Germany. Their properties are set forth in Table 3, compared to the M7D fined silica used in the prior examples These values weir provided by the companies. The BET surface area measurements correspond to average particle size; higher values correspond to smaller average particle size.

TABLE 3

| Type | Company | BET, m²/g |
|---|---|---|
| V15 | Wacker | 150 |
| M-7D | Cabot | 200 |
| N20 | Wacker | 200 |
| H20 | Wacker | 200 |
| T30 | Wacker | 300 |
| T40 | Wacker | 400 |

These fumed silicas were coated onto the surface of the solid state polymerized pellets (IV of about 0.8) of a PET containing approximately 3.0 mole % isophthalic acid. The coated pellets were injection stretch blow molded into 0.5 liter bottles. The sidewall haze and coefficient of friction were measured. The amount of silica in the bottles was measured.

It has been disclosed in U.S. Pat. No. 6,323,271 that fumed silica, polymerized in the polyester process, reduces the coefficient of friction of the surface of the injection stretch blow molded bottles made from such polymers. A polyester polymer was prepared with the same recipe above, but with the addition of fumed silica during the melt polymerization process. Table 4 summarizes the results of this Example.

TABLE 4

| | | | | Coefficient |
|---|---|---|---|---|
| Silica type | Process | Amount, ppm | Haze, % | of friction |
| Control | — | 0 | 1.6 | 7.1 |
| M-7D | polymerized | 153 | 1.7 | 0.5 |
| M-7D | coated | 125 | 5.5 | 0.3 |
| N20 | coated | 114 | 6.2 | 0.2 |
| H20 | coated | 131 | 5.8 | 0.1 |
| V15 | coated | 92 | 2.4 | 0.4 |
| V15 | coated | 131 | 5.3 | 0.3 |
| V15 | coated | 146 | 5.3 | 0.3 |
| V15 | coated | 176 | 5.8 | 0.2 |
| V15 | coated | 204 | 7.7 | 0.1 |
| T30 | coated | 88 | 3.3 | 0.2 |
| T40 | coated | 99 | 3.2 | 0.2 |

Although the coated pellet reduced the coefficient of friction of the bottle walls in all cases, the haze was significantly higher than that prepared from pellets in which the fumed silica was added during polymerization or in which no silica was added. In order to produce bottles of commercially acceptable suitable clarity the level of silica coating should be less than about 100 ppm.

### Example 4

The procedure of Example 3 was followed using the polyester resin containing 153 ppm fumed silica (M-7D), prepared in Example 3, as the control. The fumed silica used to coat the solid state polymerized pellets was Wacker V15. The bottle haze results are set forth in Table 5.

TABLE 5

| Silica coating, ppm | Bottle haze, % |
|---|---|
| 0 | 2.1 |
| 60 | 2.7 |
| 90 | 3.2 |

A coating of less than 100 ppm of silica will provide adequate anti-sticking during crystallization and solid-state polymerization, without significantly increasing the haze of the bottle.

### Example 5

Following the procedure of Example 1, various other fine particles were investigated as anti-sticking agents. They include titanium dioxide (0.2 micron), terephthalic acid (PTA, 10-50 micron), succinic anhydride (SA, 50-500 micron), synthetic silicone resins having a particle size of 12 micron and 0.5 micron (Tospearl, GE Silicones, Wilton Conn., USA), and Wacker T40 framed silica. The results of the percent stuck in the rotary flask test at various temperatures are set forth in Table 6 (the less stuck, the better).

TABLE 6

| | Control | T40 | Tospearl | Tospearl | PTA | SA | TiO₂ | TiO₂ | TiO₂ |
|---|---|---|---|---|---|---|---|---|---|
| Oil Temp | - | 0.5μ | 12μ | 0.5μ | 10-50μ | 50-500μ | 0.2μ | 0.2μ | 0.2μ |
| ° C. | 0 ppm | 70 ppm | 110 ppm | 110 ppm | 100 ppm | 100 ppm | 10 ppm | 30 ppm | 100 ppm |
| 140 | 65 | 6 | 56 | 1 | 18 | 68 | — | — | — |
| 160 | 67 | 1 | 55 | 1 | 26 | 61 | — | — | — |
| 180 | 69 | 1 | 57 | 1 | 22 | 49 | — | — | — |
| 200 | 45 | 2 | 53 | 2 | 9 | 24 | 96 | 85 | 15 |
| 210 | 81 | 3 | 37 | 2 | 42 | 64 | — | — | — |
| 220 | 81 | 5 | 39 | 2 | 47 | 60 | — | — | — |
| 230 | 86 | 5 | 51 | 2 | 55 | 62 | — | — | — |
| 240 | 88 | 15 | 10 | 3 | 63 | 68 | — | — | — |
| 250 | 89 | 25 | 45 | 11 | 72 | 86 | — | — | — |

These results illustrate the superiority of fine particles (less than 2 micron) at a coating level of less than 150 ppm, especially of fumed silica, to reduce the sticking of the pellets during crystallization.

### Example 6

Amorphous polyester pellets from Example 1 were coated with 70 ppm HDK® V15 fumed silica using two Acrison (Moonachie, N.J., USA) weigh feeders, for the pellets and the silica, feeding a Munson (Utica, N.Y., USA) rotary batch blender. These coated pellets were then used as the feedstock for a crystallizer and preheater trial. The continuous feed rate for these trials was in the range 127-145 kg/hr. The crystallizer was a TorusDisc crystallizer (Hosolkawa Bepex, Minneapolis, Minn., USA) followed by a TorusDisc preheater. The TorusDisc reactor consists of a stationary horizontal vessel containing a tubular rotor, which comprises a hollow shaft attached to 12 vertically mounted, double walled hollow discs, Heat transfer fluids flow through the shaft, the discs, and the jacketed vessel surrounding the rotor. The discs provide 85% of the heating surface. These two mechanically agitated vessels are pilot scale versions of the commercial equipment used by Hosakawa Bepex in solid phase polymerization facilities sold to the PET and polymer industry.

The feed pellets were at room temperature (22° C.) The pellet temper attire was measured in several locations within the vessel, and specifically at the ends of the two reactors at increasing pellet throughputs. The temperature of heat transfer fluid to the crystallizer was increased to a temperature (211° C.) such that the uncoated pellets did not stick to the end (hotter) discs. This was Condition I. To show the benefits of coated chips, the temperature of heat transfer fluid to the crystallizer was increased to 230° C. This was Condition II. In both Condition I and II, the temperature of heat transfer fluid to the preheater was 230° C. After steady state was achieved, the vessels were inspected to determine the number of discs to which pellets adhered. The results are set forth in Table 7 below.

TABLE 7

| | Uncoated | | Coated | |
|---|---|---|---|---|
| | Condition | Condition | Condition | Condition |
| | I | II | I | II |
| Feed Rate, kg/hr. | 127 | 155 | 141 | 158 |
| Crystallizer inlet, ° C. | 59 | 54 | 63 | 62 |
| Crystallizer outlet, ° C. | 170 | 173 | 171 | 178 |
| Preheater inlet, ° C. | 170 | 173 | 171 | 177 |
| Preheater outlet, ° C. | 218 | 216 | 219 | 219 |
| # discs with | None | all 8 | None | None |
| stuck pellets | | | | |

This trial shows that coated pellets allow the crystallizer and preheater to operate (1) at higher throughputs at the same conditions and (2) at higher throughputs without sticking at higher heating fluid temperatures.

### Example 7

450 grams of the coated amorphous pellets from Example 6 were also crystallized in a fluid bed reactor (3.8 inch internal diameter, 12 inch high). Hot air was passed through a bed of pellets to fluidize the pellets. At air velocities corresponding to 10 and 25 standard cubic feet per minute, and temperatures of 185 and 220° C., the uncoated pellets were caked into lumps together within 5 minutes, whereas the coated pellets remained free flowing when the materials were removed from the fluid bed apparatus after being exposed to the same conditions for the same time.

Analysis of the SiO₂ on the coated chip before and after the fluid bed experiment showed that the loading of the SiO₂ had not changed, this demonstrating that the high gas velocities did not substantially cause a loss in coating compound.

Thus it is apparent that there has been provided, in accordance with the invention, a process that fully satisfied the objects, aims and advantages set forth above. While the invention has been described in conjunction with specific embodiments thereof it is evident that many alternatives, modifications and variations will be apparent to those skilled in the art in light of the foregoing description. Accordingly, it is intended to embrace all such alternatives, modifications and variations as fall within the spirit and broad scope of the appended claims.

What is claimed is:

1) A method of crystallization and solid state polymerization of polymer pellets which comprises:
a) coating amorphous polymer pellets with particles having an average size of less than about 2 microns to a loading of less than about 250 ppm by weight; and
b) heating the coated pellets to a temperature effective to crystallize at least a portion of the surface of the coated pellets: and
c) subjecting said crystallized coated polymer pellets to a solid state polymerization process to increase the molecular weight.

2) The method of claim 1, wherein said polymer is polyester, polycarbonate, or polyamide.

3) The method of claim 1, wherein said coating particles can be inorganic or organic.

4) The method of claim 3, wherein said inorganic particles include minerals such as talc, kaolin, gypsum; inorganic oxides including the oxides and carbonates of silicon, aluminum, titanium, calcium, iron and magnesium; and fumed silica.

5) The method of claim 3, wherein said organic particles include alkylene carbonates, such as ethylene or propylene carbonates, terephthalic acid, phthalic anhydride, succinic anhydride, as well as particles of crystallized polymers, and carbon pigment compounds such as graphite and carbon blacks.

6) The method of claim 1, wherein said coating the pellets with the particles can be applied by dry blending with the pellets; by placing the pellets in an aqueous solution of the particles, and then removing the water; or by spraying the pellets with the particles either in the semi-solid state during extrusion or pastillation, or when they have been quenched.

7) The method of claim 1, wherein said particles have a loading of less than about 150 ppm.

8) Coated pellets comprising: polymer pellets having a surface said surface being coated with particles having an average size of less than about 2 microns to a loading of less than about 250 ppm by weight, wherein said pellets are polyester, polycarbonate, or polyamide pellets.

9) (canceled)

10) The coated pellets of claim 8, wherein said particles can be inorganic or organic.

11) The coated pellets of claim 10, wherein said inorganic particles include minerals such as talc, kaolin, gypsum; inorganic oxides including the oxides and carbonates of silicon, aluminum, titanium, calcium, iron and magnesium; and fumed silica.

12) The coated pellets of claim 10, wherein said organic particles include alkylene carbonates, such as ethylene or propylene carbonates, terephthalic acid, phthalic anhydride, succinic anhydride, as well as particles of crystallized polymers, and carbon pigment compounds such as graphite and carbon black.

13) The coated pellets of claim 8, wherein said particles have a loading of less than about 150 ppm.

14) The coated pellets of claim 8, wherein said pellets are amorphous.

15) The coated pellets of claim 8, wherein said surface of said pellets is at least partially crystalline.

16) An injection stretch blow molded container made from the coated pellets of claim 8.

17) A preform for making an injection stretch blow molded container, said preform made from the coated pellets of claim 8.

18) Fumed silica coated polymer pellets, comprising polymer pellets each having a surface coated with fumed silica particles having an average size of less than about 2 microns to a loading of less than about 150 ppm by weight, wherein said polymer is polyester or copolyester.

19) (canceled)
